(19) United States
(12) Patent Application Publication
(10) Pub. No.: US 2007/0274895 A1
(43) Pub. Date: Nov. 29, 2007

(54) Quasi-One-Dimensional Polymers Based on the Metal-Chalcogen-Halogen System

(75) Inventors: Adolf Jesih, Ljubljana (SI); Dragan Mihailovic, Ljubljana (SI); Maja Remskar, Ljubljana (SI); Ales Mrzel, Ljubljana (SI); Daniel Vrbanic, Ljubljana (SI)

Correspondence Address: MORRISON & FOERSTER LLP, 1650 TYSONS BOULEVARD, SUITE 400, MCLEAN, VA, 22102, US

(73) Assignee: Jozef Stefan Institute, Ljubljana (SI)

(21) Appl. No.: 10/582,173

(22) PCT Filed: Feb. 25, 2004
(86) PCT No.: PCT/EP04/01870

§ 371 Date: Mar. 19, 2007

(30) Foreign Application Priority Data
Dec. 8, 2003 (EP) 03028188.5

(51) Int. Cl. B01J 27/06; C01B 7/00

(52) U.S. Cl. 423/462; 423/463; 423/472; 502/224

(57) ABSTRACT

The present Invention relates a quasi-one-dimensional material with sub-micron cross-section described by the formula M₆C_{y}H_{z}, where the M=transition metal, C=chalcogen, H=halogen, and where y and z are integers such that 8.2<y+z<10, which materials are synthesized in a Single-step procedure at temperatures above 1000° C. The present invention also concerns the use of these materials in electronic, chemical, optical or mechanical applications.

The present invention relates to air-stable, monodisperse quasi-one-dimensional materials synthesized with sub-micron cross-section and described by the formula M₆C_{y}H_{z}, wherein M=transition metal, C=chalcogen, H=halogen, and wherein y and z are real numbers such that 8.2<(y+z)<10. These materials may be synthesized in a single-step procedure at temperatures above 1000° C. The present invention also concerns the use of these materials in electronic, chemical, optical or mechanical applications.

### BACKGROUND OF THE INVENTION

Carbon nanotubes as reported by Ijima (I. Ijima, Nature 56 (1991), 354) have many functional properties, which makes them important in numerous different applications, ranging from nanoelectronics to components in composites, as chemical and nano-electromechanical sensors and various other devices (R. H. Baughman, A. A. Zakhidov and Walt A. de Heer, Science 297 (2002), 789). Carbon nanotubes are typically synthesized in such a way that many different varieties of material are grown simultaneously, so that the nanotubes typically grow all of different diameters, chiralities and with different physical and electronic properties. Moreover the use of metal catalysts in the synthesis strongly inhibits the separation of nanotubes without damage. The catalyst particles are typically covered with carbon layers, which also covalently bind to the nanotubes making separation exceedingly difficult. Also, the synthesis methods presently used, such as in an arc discharge or by laser ablation, are rather unsuitable for easy scaling up of production volume of monodisperse single-species nanotubes or nanowires.

Inorganic nanotubes based on transition metal chalcogenides have been synthesized and proposed as a possible alternative to carbon nanotubes in many existing applications and some new ones. U.S. Pat. No. 6,217,843, (Appl. No. 308663) and U.S. Pat. No. 5,958,358 (Appl. No. 657431)) refer to a method of preparation of nanoparticles of metal oxides and to metal-intercalated and/or metal caged “inorganic fullerene-like” structures of metal chalcogenides obtained therefrom fullerene-like structures of dichalcogenide nanotubes. However, the materials synthesized in this way are non-monodisperse, contain a small proportion of single-wall and multi-wall nanotubes with different diameters and diverse wall layer thicknesses, onion-like multi-layer fullerene structures and other materials. Although no catalyst particles are present, separation of the material synthesized in this way into specific components is difficult, and use of any one of the components is consequently very limited for many applications. Moreover the synthesis procedure described in the above patents involves multiple steps and cannot be easily performed by a single step process, making scaling up relatively difficult.

Remŝkar M. et al. (Science 292 (2001), 479-481) and PCT/SI01/00027 refer to the synthesis of quasi-one-dimensional nanostructures, called bundles of nanotubes in a fullerene-assisted transport reaction and have a formula MoS₂I_{1/3}. The synthesis of the material requires a transport reaction, which is relatively complex, and is not suitable for applications where larger amounts of material are required.

Many different compounds in the ternary system Mo—S—I are known, but do not have the desirable quasi-one-dimensional properties relevant for nano-scale applications. C. Perrin et al. describe in Soc. Chim. France 8 (1972), 3086) the synthesis of Mo₂S₅I₃, and V. E. Fedorov et al. refer in Sibir. Ord. Akad. Nauk SSSR, Ser. Khim. Nauk 6 (1978), 56 to synthesis of compound Mo₃S₇I₄, while C. Perrin et al. refer in Acad. Sci. Paris C 280 (1975), 949,) to the synthesis of Mo₄S₄I₄. The article of M. Potel et al. in Revue de Chimie minerale, 21 (1984), 509 reports the synthesis of Mo₆S₈, Mo₉S₁₁, Mo₁₅Se₁₉ and Mo₆C₆ (C=chalcogen). C. Perrin and M. Sergent refer in J. Chem. Res (S) 38 (1983) to the synthesis of Mo₆S₂I₈. The article of R. Chevrel et al. in J. Sol. Stat. Chem. 3 (1971), 515 reports the synthesis of new ternary sulfurated phases of molybdenum with the general formula M_{W}Mo₆Se₈ (wherein M is a metal and w<4). However, none of the above mentioned materials have been reported to grow with a one-dimensional morphology or have a structure, which can be described as sufficiently one-dimensional to allow applications as nanowires or nanorods.

The articles of F. Jellinek (Nature 192, (1961), 1065) and Jellinek et al. (Acta Cryst. B24 (1968), 1102) describe the synthesis of Nb₂Se₃ and Ta₂Se₃, which are described as needle-like mm-size crystals, and whose crystal structure have been determined to be quasi-one-dimensional. The structure of Mo_{2.065}S₃ is reported by R. Deblieck et al. in 1983 (Phys. Stat. Solidi 77 (1983), 249). These materials do not grow in the form of nanowires or nanorods, however and are not known to be dispersible into nanowires or nanorods.

The article of R. Chevrel et al. (Mat. Res. Bull. 9 (1974), 1487) reports on the synthesis of Mo₃S₄, while the analogues Mo₃Se₄ (A. Opalowski and V. Fedorov, Iz. Akad. Nauk SSSR Neorg. Mat. 2-3 (1966), 443) and Mo₃Te₄ (M. Spiesser, thesis, 1971) are also known to exist. The morphology of the materials is not quasi-one-dimensional, however.

P. C. Perrin et al. describe in Acta Crystallographica C 39 (1983), 415 the synthesis of Mo₆Br₆S₃ at a temperature of 1200° C. which is a two-dimensional layered material and grows in the form of platelets, not nanowires or nanorods or quasi-one-dimensional objects.

Sergent M. et al. describe in the Journal of Solid State Chemistry 22 (1977), 87-92 the synthesis of a series of quasi-one-dimensional compounds which are composed of transition metal clusters, surrounded by chalcogen atoms and other transition metal ions or alkali metal ions with the formula M₆C₆H₂ wherein M is a transition metal ion, C is a chalcogen and H is Br or I. In the article L. Sol. Stat. Chem. 35 (1980), 286-290,) M. Potel et al. describe a series of similar compounds with interstitial substitutions with the formulae M₂Mo₆Se₆ (M=Na, In, K, Tl), M₂Mo₆S₆ (M=K, Rb, Cs) and M₂Mo₆Te₆ (M=In, Tl). Tarascon et al. in J. Sol. Stat. Chem. 58 (1985), 290), and Hornbostel et al. in Nanotechnology 6 (1995) 87-91 report that M₂Mo₆C₆ (C=Se, Te and M=Li or Na) can be dispersed in various highly polar solvents such as dimeythylsufoxide or N-methylformamide into fibers as described. These fibers are produced by two-step synthesis first of InMo₃Se₃ and then oxidized in solution with HCl to give (Mo₃Se₃)_{∞} fibers. The fibers produced this way can be stabilized by solvated ions in solution, but they are unstable in air and are not really suitable for applications as individual nanofibers or nanowires.

A problem of the present invention is to provide improved materials, which may be used in a variety of different applications such as nano-electromechanical devices or sensors (NEMS).

### SUMMARY OF THE INVENTION

This problem has been solved by providing novel quasi-one-dimensional materials which grow in the form of nanowires of sub-micron cross-section of the general formula M₆C_{y}H_{z}, wherein M=transition metal, C=chalcogen, H=halogen, and wherein y and z are real numbers such that 8.2<(y+z)<10, which are synthesized in a single-step procedure at temperatures above 1000° C.

During extensive experiments the present inventors surprisingly noted that when maintaining a ratio of the above indicated ingredients within the limits of 8.2<(y+z)<10 and performing the method of synthesis at a temperature exceeding 1000° C., always materials showing a quasi three dimensional structure (i.e. being in the form of three dimensional crystals) are obtained which are air stable in contrast to prior art materials. Without wishing to be bound to any theory, the as-grown material structure are considered to represent bundles exhibiting a small diameter with 1-dimensional subunits, whose structure is wire-like at the molecular level, or bundles of one-dimensional polymers of Mo₆S_{y}I_{z}, clusters, or bundles composed of inorganic molecular wires.

The materials have the advantages that the bundles of (Mo₆S_{y}I_{z}) may be controllably dispersed into smaller ones, obtaining monodisperse dispersions of different diameters, the dispersed samples are stable in air and the synthesis of the material is straightforward (as compared e.g. to carbon nanotubes, which are functionally similar). The material obtained in this way does not contain significant amounts of impurities, with the impurities still present not being chemically attached to the bundles of the material, while the as-grown wires may be longer than 1 mm, with sub-micron diameter.

In the Figures,

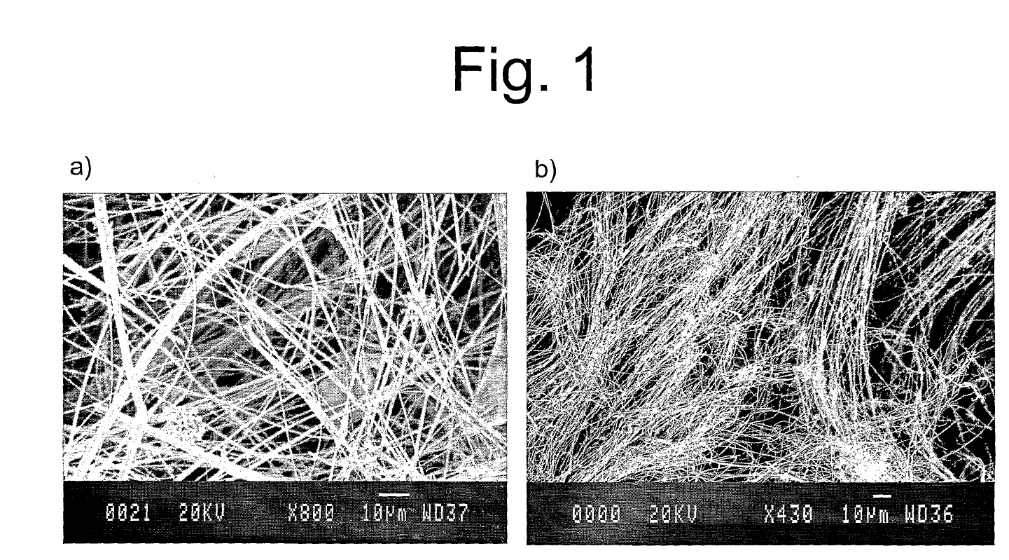

FIG. 1a is a typical SEM image of Mo₆S₃I₆ nanowires (the scale bar represents 10 μm);

FIG. 1b is a typical SEM image of Mo₆S₃I₆ nanowires (the scale bar represents 10 μm);

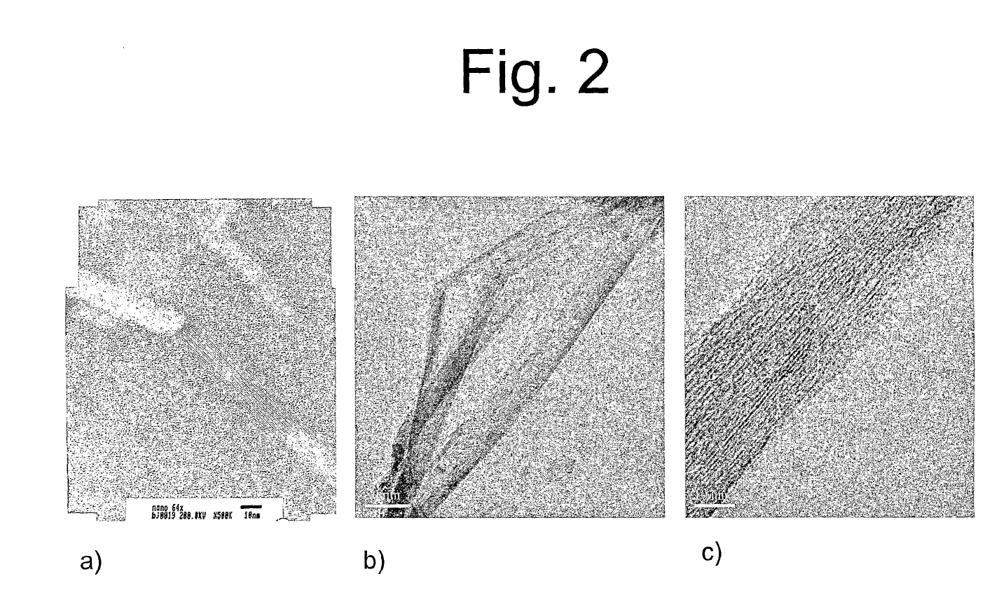

FIG. 2a is a typical HRTEM image of Mo₆S₃I₆ nanowire in the longitudinal direction (the scale bar represents 10 nm);

FIG. 2b is a typical TEM image of Mo₆S_{4.5}I_{4.5} nanowire (the scale bar represents 50 nm);

FIG. 2c is a typical TEM image of Mo₆S_{4.5}I_{4.5} nanowire (the scale bar represents 10 nm);

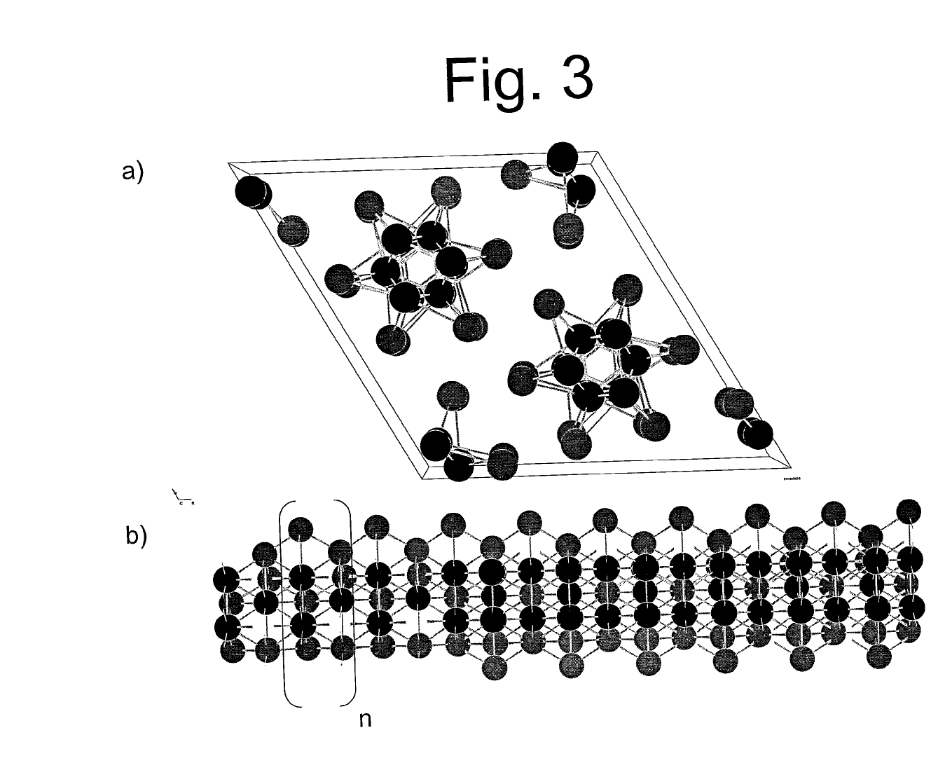

FIG. 3a shows a hypothetical structure showing the cross-section of a bundle of nanowires.

FIG. 3b shows a hypothetical structure of a short section of an individual molecular unit viewed from the side with repeat unit indicted within the brackets. Atoms may be replaced, or may be in different positions or may be missing.

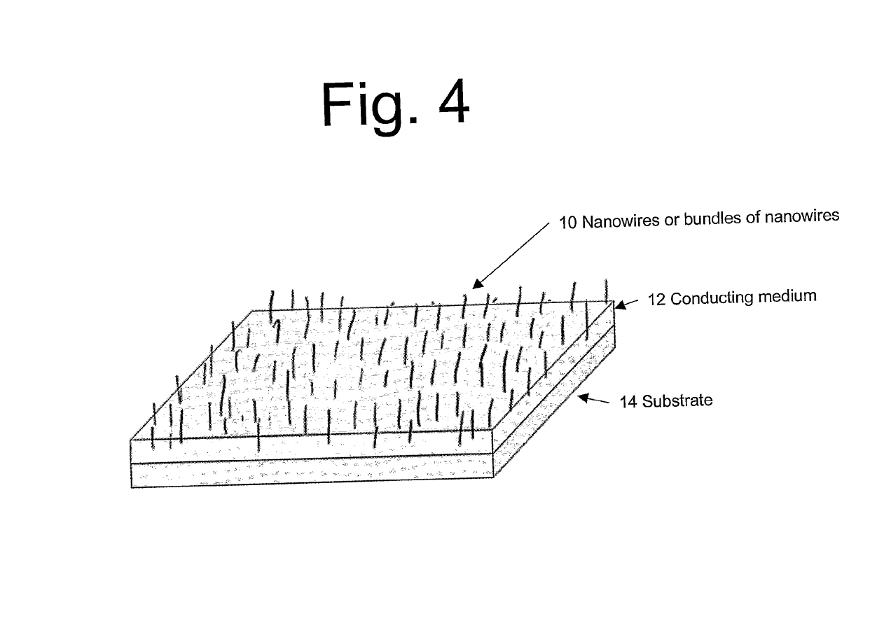

FIG. 4 is a schematic diagram of a field emission electrode using nanowires of a material according to the present invention and bundles thereof in a conducting matrix.

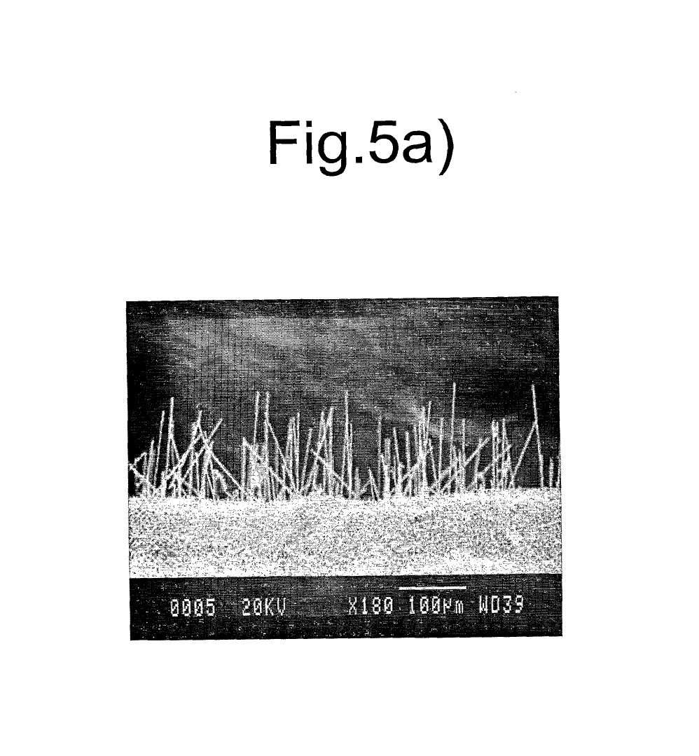

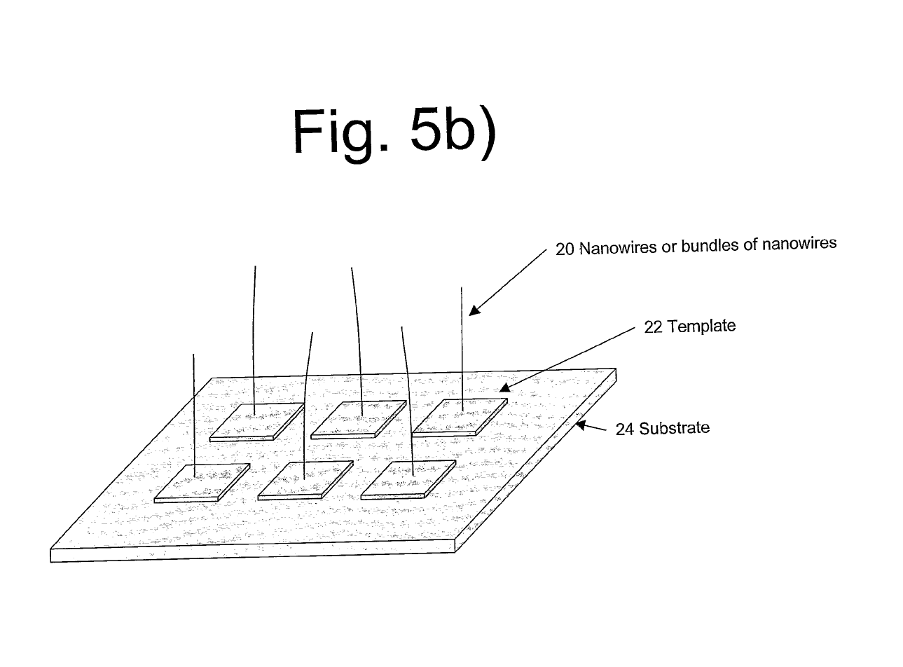

FIG. 5a shows scanning electron microscope images of Mo₆S_{y}I_{z} nanowires grown on a Mo metal substrate under conditions corresponding to those given in Example 1. (The scale bar represents 100 μm).

FIG. 5b is a schematic diagram of template grown M₆C_{y}H_{z} material.

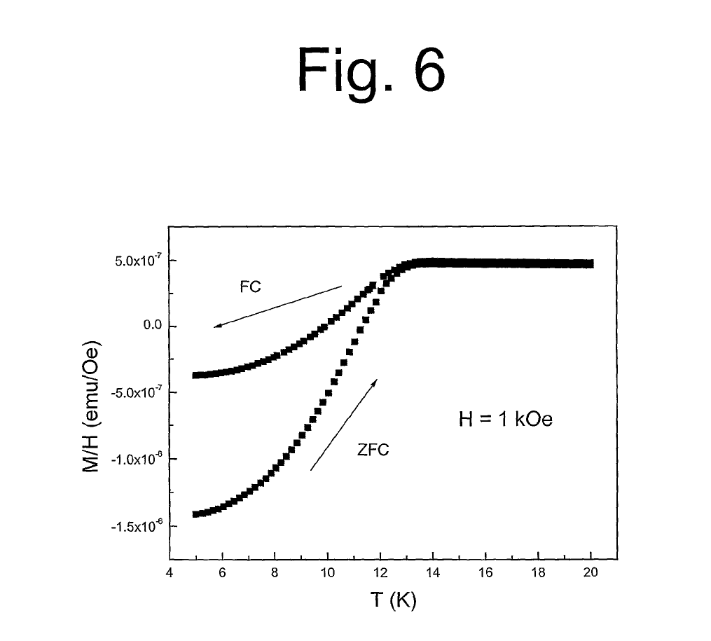

FIG. 6 shows the magnetic susceptibility of Mo₆S₃I₆ exhibiting magnetic field exclusion via the superconducting Meissner effect.

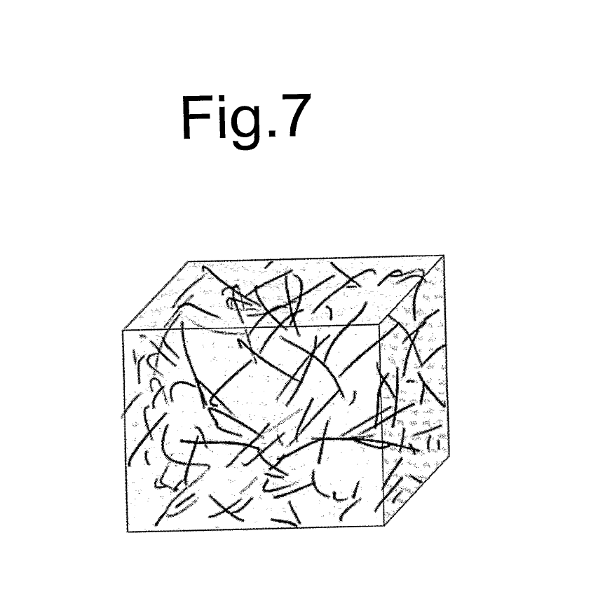

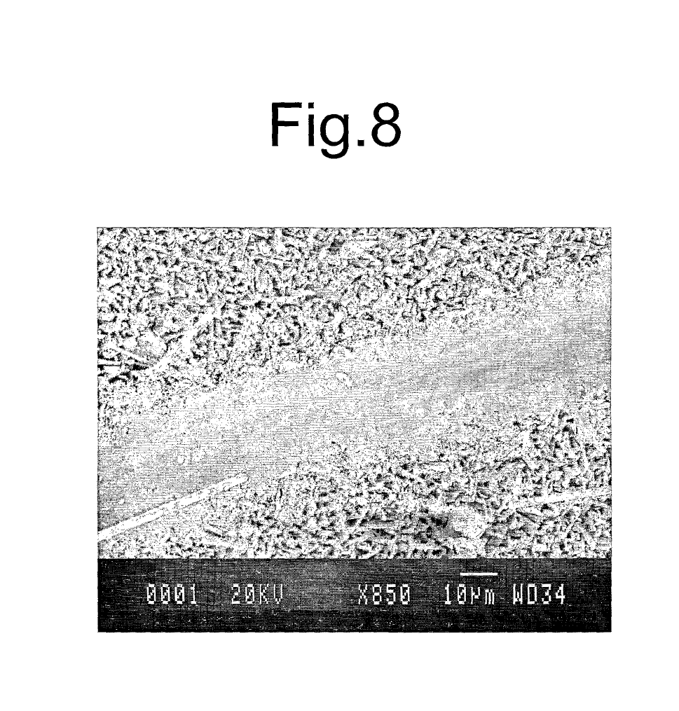

FIG. 7 is an example of a composite material incorporating M₆C_{y}H_{z} nanowires or bundles thereof.

FIG. 8 is a surface coating of M₆C₃H₆ material (The scale bar represents 10 μm.)

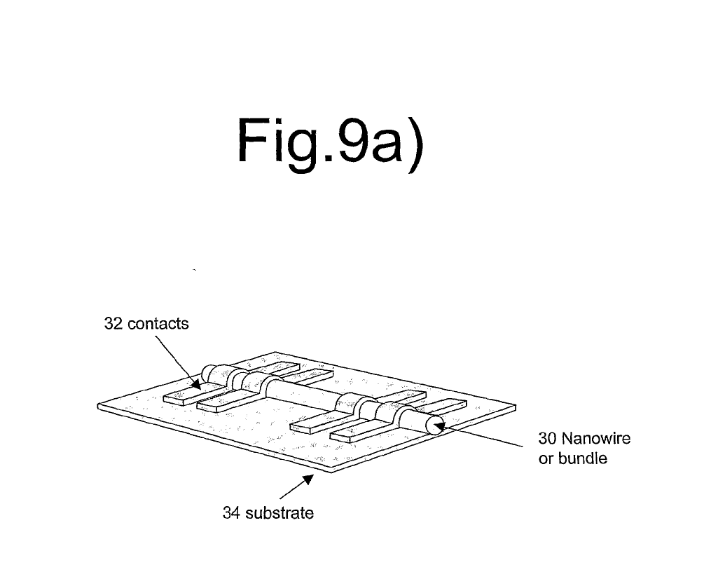

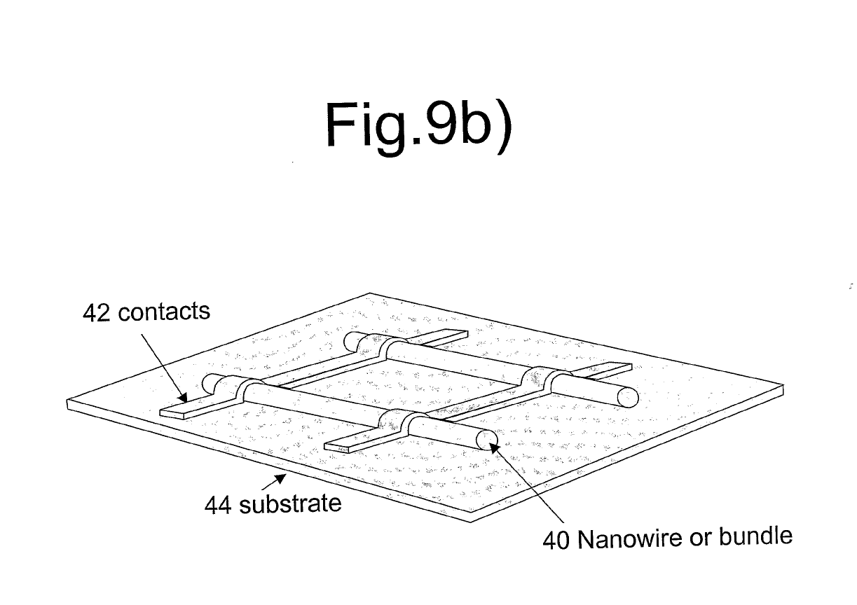

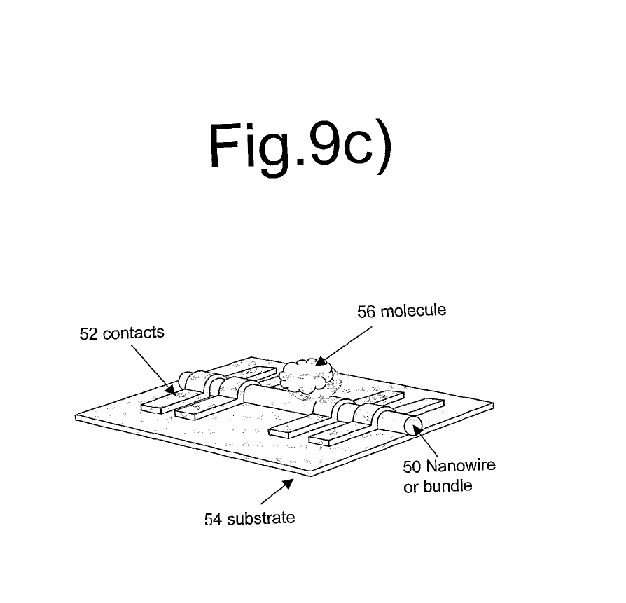

FIG. 9a shows a 4-terminal device incorporating a M₆C_{y}H_{z} nanowire or bundle of nanowires.

FIG. 9b shows a quantum interferometer using two M₆C_{y}H_{z} nanowires or bundles of nanowires as arms. The contacts may be made e.g. of superconductor, or metal or M₆C_{y}H_{z} nanowires or bundles thereof.

FIG. 9c shows a molecular sensor whereby the impedance of the device is changed by the attachment of a molecule or molecules.

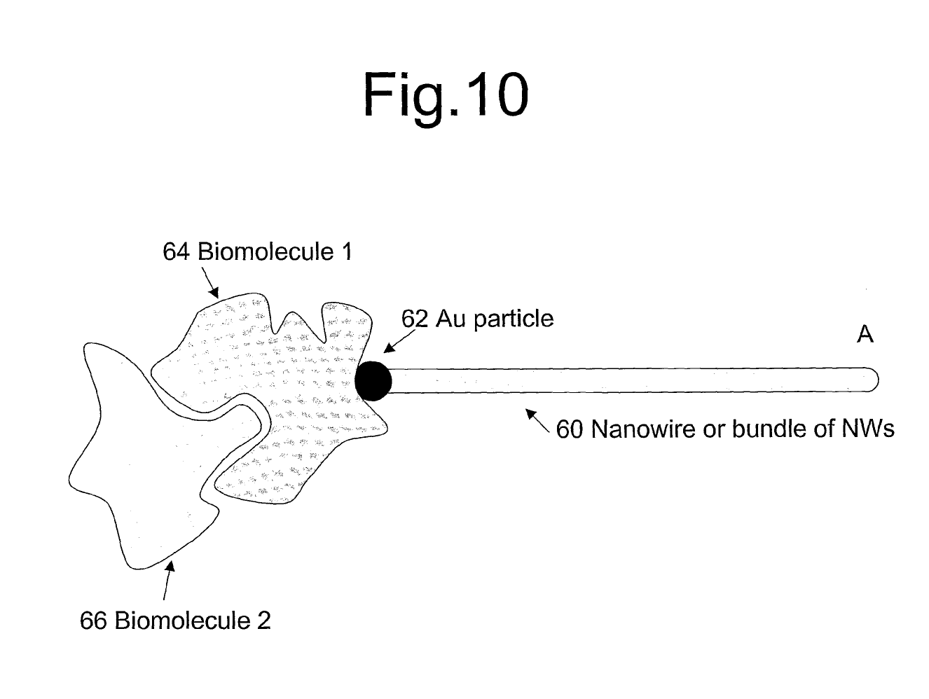

FIG. 10 shows an example of a sensing device utilizing a M₆C_{y}H_{z} nanowire or bundle, attached to a gold particle which in turn has an attached molecule, in particular an antibody. An antibody detects antigens via the lock and key principle. The attachment is detected by monitoring properties of the M₆C_{y}H_{z} nanowire, such as impedance, resonant frequency or another property which changes upon attachment or removal of molecules from the device.

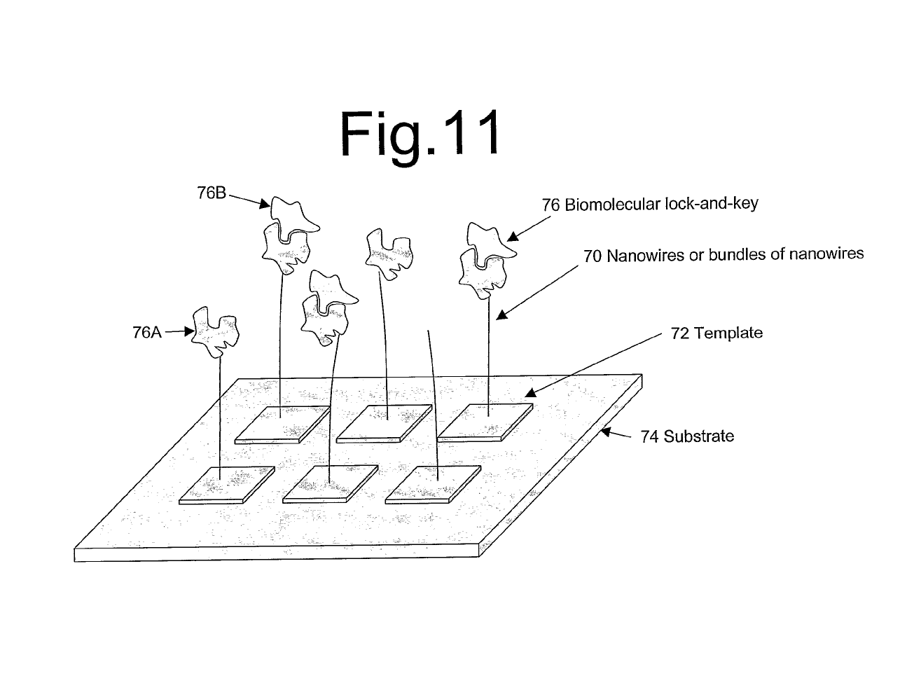

FIG. 11 shows an example of an array or a device incorporating template-grown M₆C_{y}H_{z} nanowire bundles with attached biomolecular sensors.

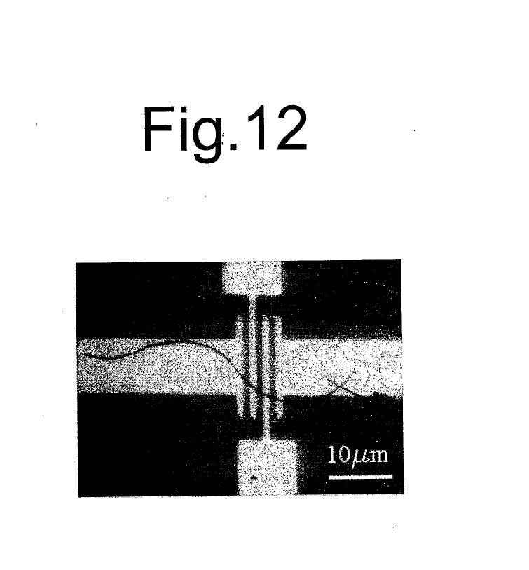

FIG. 12 is a 4-terminal device in which a Mo₆S_{4.5}I_{4.5} nanowire or bundle of nanowires is deposited on the contacts by dielectrophoresis.

The compounds in the present invention differ from the known materials described in the first section by their stoichiometry and/or their composition. The materials are stable in air and may be prepared in suspensions in polar fluids, such as water as well as non-polar organic liquids. It may be used in applications for field emission tips, as lubricants, in nanoelectronics and batteries, as sensor templates etc., and can be doped with other alkali ions or molecules, with a wide range of potential applications.

According to a preferred embodiment the material M is a transition metal selected from the group consisting of Mo, W, V, Ti, Ta, Nb, Zn, Hf, Re and Ru.

C may be any chalcogen or mixture of chalcogens, but is preferably sulfur, selenium or tellurium. H may be any halogen or mixture of halogens, but is preferably Iodine or Bromide.

According to another preferred embodiment 0<y<10 and 0≦z<10 while y+z>8.2. Also, in a specific embodiment, 8.2<(y+z)<10 and preferably y+z=9.

The invention relates to carbon nanotubes in that the form of growth and synthesis and preparation is such that it gives rise to similar appearance on the nanoscale. As is described by the terminology used in the field, the form of nanoropes, nanorods and nanowires.

The invention relates to previous synthesis of M₆C₈₋ₓTₓ, (M=transition metal, C=chalcogen, T=transition metal) and M₆C₈₋ₓAₓ, (M=transition metal, C=chalcogen, A=alkali metal) all of which are synthesized below 1000° C. The present invention differs from the compounds described in the previous statement by the synthesis being performed above 1000° C., surprisingly yielding quasi-one dimensional objects in the form of nanoneedles, nanorods, nanowires or nanowhiskers.

The present invention also relates to previously known forms of transition metal chalcogenide halides with different stoichiometry, namely 662 stoichiometry, such as Mo₆Se₆I₂, which grow in the form of well-defined crystals. These materials have a well-defined crystal structure and also grow in the form of whiskers or rods. The present invention covers stoichiometries which differ from 662. The structural coherence is not easily measurable over distances more than 50 nm, arising from intrinsic reasons, such as bending or malleability of the material, which distinguishes the materials in this invention from crystalline whiskers or small crystals.

The present invention relates to chain compounds with the formula MₓC_{y} such as Mo₂S₃ which have a different stoichiometry.

The present invention relates to a MₓC_{y}H_{z} material such as MoS₂I_{1/3} which is grown in a modified transport reaction involving fullerenes such as C₆₀ and C₇₀. The present invention refers to material which differs from compounds such as MoS₂I_{1/3} by the method of synthesis and by stoichiometry.

The invention relates to items and devices, methods of making and using them and related systems on the scale of nanometers and micrometers.

The present materials may be used in composites with enhanced mechanical, thermal or electrical properties, as battery electrodes, it may be doped with electrons or holes, as nanoconnectors, in nanodevices (e.g. FETs) in either metallic or semiconducting form depending on doping, connected to gold particles, as replacement material for carbon nanotubes, in applications which require one-dimensional structure or properties arising from confinement of electrons to one dimension, as field emission tips, as coatings, as catalyst, as superconductors, as carriers for functionalized sensors and detectors, as material utilizing special chemical properties for attachment of various kinds of molecules or to surfaces, as solid-state lubricant and as additive material in liquid lubricants.

In particular, the present materials may be embodied in a thin film or single rope, strand, needle, whisker or wire of said material deposited by evaporation of solvents, or electrodeposition including electrophoresis, dielectrophoresis etc., or in device made of single strands, multi-strand whiskers, ropes or rods of the Mo—S—I system, with items (i.e. atoms, molecules, contacts) attached either by van der Waals forces, via charge transfer or covalent bonding for purposes of functionalization and use for sensors, detectors, in which the specific chemical properties of the Mo—S—I materials are utilized, or as functionalised single strands, multi-strand whiskers, ropes or rods of the Mo—S—I system as in claim above in which a bond is made to the chalcogen (e.g. sulphur) or transition metal (e.g. molybdenum) or halogen (iodine).

Said structures, which, when incorporated into devices using attached gold particles can form sensors, or on surfaces as films, used as an interface to temporary or permanent attachment of organic molecules via sulphur and/or carbon atom.

In another embodiment, the invention is embodied as a conducting or superconducting wire, or rope or rod or whisker, composed of smaller wires, etc. which range in diameter from 0.6 nanometers to 10 micrometers.

Said structures, which when dispersed into smaller bundles, ropes or individual tubes can act as lubricants, additives to lubricants, or components in composite materials in which friction can be reduced with or without the combination of increased strengths and/or enhanced electrical or thermal properties.

In one aspect, the invention comprises the methods of growing, assembling and otherwise making articles and devices. In one embodiment a method of the invention involves growing rod-like, wire-like or rope-like objects composed of smaller quasi-one-dimensional subunits made of transition metal and chalcogen in various stoichiometry. In another embodiment, in addition to transition metal and chalcogen the objects may contain also other doped atoms or ions, or interstitial atoms, ions or molecules including halogens, other transition metals, rare-earth metals, organic donors etc.

In one embodiment, the invention pertains to the synthesis of material under specific conditions above 1000° C. which has a particular shape of microrods, nanorods and nanowires, nanowhiskers, nanoropes, ranging in diameters from a few microns to a few nanometers. These microrods, nanorods and nanowires are typically composite objects, composed of thin one-dimensional objects such as wires, strings or clusters of atoms arranged in straight or staggered chains or ladders.

In another embodiment the invention is described as material whose wire-like or rod-like shape concentrates electric fields at their tips.

In another embodiment the invention is described as a conducting nanowire, nanorope, nanorod, etc. of intertwined strands of smaller wires, strands ranging in diameter from 0.6 nm to 10000 nm.

As outlined above, the material according to the present invention can be used in various applications, whereof some will be described exemplarily more detailed below.

The material according to the present invention may be used in field-emission devices. In particular, the electron-emitting cathode of field-emission devices can be made by mixing nanowires or nanowire bundles of a material according to the present invention with conducting material such as conducting polymer(s), for example indium or lead metal, for example silver or graphite paste, for example, or polyaniline or other conducing polymer in order to form a conducting path to the individual nanowires or bundles. FIG. 4 shows schematically a field emission electrode using Mo₆S_{y}I_{z} nanowires 10 or bundles 10 thereof, which nanowires or bundles are partially embedded in a conducting medium 12 and protruding therefrom. Medium 12 is applied on substrate 14. The specific nanowire material, the material of the conducting medium and the substrate material may be chosen according to the general knowledge in the art of a skilled person. The material of the substrate can be for example copper, nickel or other metal, free-standing or on a substrate of another material, for example quartz or fused silica.

The electrode for a field-emission device can be treated by processes of the state of the art, such as e.g. heating and annealing processes, to improve the electrical contact between said material or bundle thereof and contact made of metal such as Au, Ag or Ti or similar. The surface of the electrode may be subsequently treated to increase the protrusion characteristics, i.e. the length of protruding nanowires or nanobundles, and to improve their uniformity, such as e.g. by chemical etching, plasma etching, dissolving in solvent or other treatment, such as mechanical polishing or brushing.

According to another approach, the nanowires for field emission applications can be grown on a constituent metal. FIG. 5a shows scanning electron microscope images of Mo₆S_{y}I_{z} nanowires grown on a Mo metal substrate, under conditions corresponding to those given in Example 1. The scale bar given in FIG. 5a has a length of 100 μm. The nanowires for field emission applications can also be grown on other metal substrates, which may be chosen depending on the respective desired application according to the general knowledge in the art of a skilled person. When desired, said metal substrate can be templated, for example, by etching, or by patterning the surface of the substrate with a particle beam, such as an ion beam or electron beam, or by laser beam, as shown in FIG. 5b. FIG. 5b shows a schematic diagram of a M₆C_{y}H_{z} material grown in form of nanowires 20 or bundles of nanowires 20. These nanowires 20 or bundles of nanowires 20 are grown on a template 22, which template is present on substrate 24. The specific nanowire material, the material of the conducting medium and the substrate material may be chosen according to the general knowledge in the art of a skilled person. The material of the substrate can be for example quartz or fused silica, on a flat or curved surface. The material of the template can be for example Mo or other transition metal. The material of the substrate can be the same material as the material of the template or can be a different material. For example, a template, such as e.g. made of Mo, can be formed on a different material, such as e.g. quartz and patterned using various best available methods to achieve desired shape or pattern. According to the general knowledge of a skilled person in the art, the material can be grown from the substrate in such a way to improve and/or control field emission efficiency, for example by adjustment of template geometry, growth conditions, such as e.g. temperature or atomic composition, for achieving optimum separation, length and diameter of protruding nanowires or bundles of nanowires, or physical characteristics, such as contact resistance, etc.

The material according to the present invention can also be used as a superconductor, utilizing intrinsic superconducting properties of nanowires. In case of a material according to the present invention, for example, in magnetic shielding applications of the superconductor, the temperature dependence of the magnetic susceptibility χ of Mo₆S₃I₆ may be seen (FIG. 6). As shown in FIG. 6, Mo₆S₃I₆ material according to the present invention provides a Meissner effect exhibiting magnetic field exclusion below a critical temperature of T_{c}=13.5K. FIG. 6 is a plot illustrating the temperature-depending variations of the ratio M/H (torque/magnetic filed strength) at a given magnetic field strength H of 1 kOe (kiloOersted). The arrows indicate the different behavior of the material when cooling down in the presence of a magnetic field (arrow pointing down)) or heating after first cooling to 4 K in the absence of a magnetic field (arrow pointing up) of said Mo₆S₃I₆ material according to the present invention.

Another superconducting application of nanowires according to the present invention uses bundles of the material either pressed together or arranged according to the knowledge of a skilled person to enable Josephson tunnelling and phase coherence between individual bundles, or in the form of single strands or nanowires of different diameters which exhibit different superconducting properties, depending on their diameter, composition or stoichiometry.

The nanowire superconductor can be used in combination with another material in devices using metal or insulating contacts to form superconductor-metal, superconductor-insulator or superconductor-superconductor junctions.

The material according to the present invention can also be mixed, for example by melting within another material, or sintering with other material(s), such as a metal, to make a proximity-coupled network, or with another superconductor, to enhance its properties, for superconducting wire applications.

The material according to the present invention can also be used for the construction of quantum devices utilizing the one-dimensional nature of the material to construct self-assembled or engineered quantum interference networks.

Moreover, the material according to the present invention can be used for lubricating applications. For this purpose, the material according to the present invention can be either used as such as a lubricating agent, for example as-grown, or in combination with other materials or as additive(s) to oils as described in the art e.g. for layered MoS₂ (B. Bhushan and B. K. Gupta, Handbook ok Tribology. McGraw-Hill, New York. 1991) or nanoparticles of MoS₂ (L. Cizaire, B. Vacher, T. Le-Mogne, J. M. Martin, L. Rapoport, A. Margolin, and R. Tenne. Surface and Coatings Technology 160 (2002) 282-287), which documents are herewith incorporated by reference. The materials of the present invention have the important advantage that the forces between individual wires are very weak, similar to those shown for MoS₂I_{1/3} (A. Kis, D. Mihailovic, M. Remskar, A. Mrzel, A. Jesih, I. Piwonski, A. J. Kulik, W. Benoit, and L. Forró. Advanced Materials 15 (2003) 733-736), with resulting excellent tribological properties.

The wires, which are electrically conducting, superconducting or semiconducting, can also be incorporated into plastic polymers, as shown in FIG. 7, and thereby enhance the electrical, (such as e.g. pyroelectric, ferroelectric, ferroelastic, conducting), optical, magnetic, mechanical and tribological properties of said polymers. FIG. 7 shows schematically a cube of polymer material, wherein material according to the present invention is embedded. Materials according to the present invention, in particular Mo₆S_{y}I_{z} materials according to the present invention, can be used in combination with additional chemical agents for enhancing the bond to the host material, such as e.g. oxidants, or without such agents. The addition of materials according to the present invention, for example of a Mo₆S_{y}I_{z} material, to essentially transparent polymers or glasses can be used to enhance the non-linear optical characteristics of said essentially transparent polymers or glasses. Examples for polymers or glasses are e.g. epoxy resins, polyethylene, polyaniline, PPV (polyphenylenevinylene), PVA (polyvinyl acetates), PMMA (polymethyl methacrylate), window glass, silica glass.

In addition, the nanowire material of the present invention can be grown in the form of thin layers on surfaces for enhancing the surface friction of said surfaces. For example, the M₆C_{y}H_{z} material of the present invention can be material grown directly on the desired surface. Alternatively, the material of the present invention can be grown by means of an intermediate layer, for example of constituent metal such as molybdenum, which is used in the reaction with chalcogen and halogen to form a surface coating comprising molybenum, chalcogen and halogen, and in particular a coating having the formula M₆C_{y}H₂, as shown in FIG. 8. In FIG. 8, a diagonal section shows the deformed surface coating after mechanical abrasion, while the adjacent sections are virgin coated with said surface coating comprising molybenum, chalcogen and halogen. The scale bar as shown on the scanning electron microscope image has a length of 10 μm. A growing of material according the present invention on such a coating provides the advantage that the material according to the present invention may be rather easily “harvested” from said surface coating or coated with metal or other material for achieving special functional properties.

Moreover, the present invention provides also a method of varying or controlling the material characteristics of a material according to the present invention. The characteristics of said material can be varied by changing composition parameters y and z to selected composition parameter values, for example by varying the ratio of typically 2-valent chalcogen to one-valent halogen, and thus also varying the electronic properties as a result of the different valence of said constituent halogen and chalcogen atoms. For varying the characteristics of the materials of the present invention also an incorporation of different dopants or substituents can be used, what will for example change the electronic or magnetic properties of the materials of the present invention. Such variations can be achieved according to the general knowledge in the art, for example by doping in solution or directly doping by vapour phase substitution, or by addition of further elements, such as e.g. transition metals like In, Pb or alkali or alkaline-earth metals, when synthesizing the material according to the present invention or by electrochemical doping. For example, alkali metal doping, such as lithium doping, can result in electron transfer to the M₆C_{y}H_{z} material, altering its magnetic and electronic properties.

The present invention also provides devices, in particular electric devices, comprising a material or a material bundle according to the present invention, for example a nanowire or a bundle of nanowires. In the present application the term “electric” encompasses also the term “electronic”. An electric device comprising a material or a bundle of one or more material(s) according to the present invention as claimed in the present application comprises any device, wherein a material or a material bundle according to the present invention is incorporated. In particular, such a device comprises at least one material or material bundle, for example a nanowire or bundle of nanowires arranged on a substrate, said material being a material according to the present invention. In addition thereto, such a device comprises at least one contact arranged on said substrate and passing over said at least one material or material bundle, said at least one contact being connected with or connectable to circuitry of the device. Such a device according to the present invention can for example detect physical or chemical influences acting on said at least one material or material bundle and/or said at least one contact. For example, such a device can be adapted to detect physical or chemical influences selected from the group consisting of influences due to molecules attaching to and/or coming into contact with said at least one material or material bundle or said contact(s), due to light of different wavelengths, and due to mechanical or chemical influences.

The material of substrate and contacts can be chosen according to the general knowledge of a skilled person in the art and can comprise the substrate and contact materials explicitly indicated herein, but is not restricted to said materials. For example, the substrate can be made of glass or silicon or silicon oxide, or metal, or plastic. The contacts can be made for example of superconductor, such as Nb, or metal, such as Au, or M₆C_{y}H_{z} nanowires or bundles thereof. In particular, the substrate may also be covered, partially or completely, with one or more layers or coatings.

Electronic devices can be based on an arrangement which incorporates nanowires in 2-, 3-, 4- or multi-terminal configuration, as shown for example in FIG. 9a or 9b. FIG. 9a presents a nanowire or a bundle of nanowires 30 on a substrate 34 having four contacts 32, i.e. an arrangement having a 4-terminal configuration. FIG. 9b shows a quantum interferometer using two M₆C_{y}H_{z} nanowires or bundles of nanowires as arms. The contacts may be made for example of superconductor, such as e.g. Nb or other metal. In particular, FIG. 9b presents two adjacent nanowires or bundles of nanowires 40 on a substrate 44 provided with two contacts 42, whereof each contact passes over both nanowires or bundles of nanowires, i.e. a 2-terminal-configuration. Molecules can attach from solution, as well as from gas phase to such a 2-, 3-, 4- or multi-terminal-device. FIG. 9c shows the nanowire arrangement of FIG. 9a, wherein a molecule 56 attaches to the nanowire or the bundle of nanowires 50 fixed by contacts 52 on substrate 54. An attachment of molecules to a multi-terminal device incorporating nanowires or bundles thereof can be used as a sensor detecting an attachment of molecules by detecting changes in physical properties associated with said device, e.g. device impedance or resonant frequency changes (FIG. 9c)

Another application of such devices incorporating nanowire networks, individual bundles or nanowires in 2-, 3- or 4-terminal devices is a detection of an external electromagnetic field, via change of impedance (e.g. via a magnetoresistive or via a field-effect), the detection and conversion into electrical form of light of different wavelengths (e.g. via detection of wavelength-dependent photoconductivity or photovoltaic effect), or of mechanical influences which change the impedance of the material.

Gas sensors utilizing M₆C_{y}H_{z} material, in particular Mo₆S_{y}I_{z} material, according to the present invention are based on the measurement of electrical impedance (conductivity or capacitance) of networks of bundles, such as e.g. shown in FIG. 1a or 1b, since gases or vapors surrounding said networks change the electrical characteristics of said networks. The sensor relies on the fact that molecules which attach to individual bundles and/or attach in between the contacts of the bundles to other molecules or individual wires, will cause a small change in electronic properties, and will thus cause a change in the complex impedance of the network.

The present invention also provides a method of arranging a material according to the present invention in an electric device, said method comprising the steps of arranging at least one material or material bundle, for example at least one nanowire or bundle of nanowires, on a substrate, said material being a material according to the present invention; and providing said at least one material or material bundle with one or more contacts, at least one of said one or more contacts being in connection with or connectable to circuitry of the device.

According to another aspect of the present invention, an array comprising a material according to the present invention or a bundle of material(s) according to the present invention is provided. The term “array” as used in the present application pertains to any physical arrangement comprising at least one material or material bundle, for example at least one nanowire or bundle of nanowires, said material being a material according to the present invention. An array comprises at least one material or material bundle, said at least one material or material bundle being provided on a substrate, the length axis of said at least one material or material bundle extending essentially non-parallel to said substrate, and said at least one material or material bundle being provided with a molecule on the end distant from said substrate. In particular, the at least one material or material bundle is attached to said substrate or attached to a template arranged on said substrate and said molecule can be attached via a particle, preferably via a gold particle, to said at least one material or material bundle.

The material of substrate, template and particle can be chosen according to the general knowledge of a skilled person in the art and can comprise the substrate and contact materials explicitly indicated herein, but is not restricted to said materials. For example, a glass substrate covered with conducting polymer or other conducting material for improving electrical contact may be used to connect to a bundle or single molecular wire of material which is connected to a biologically active particle. In particular, the substrate may also be covered, partially or completely, with one or more layers or coatings.

Sensors of materials, in particular nanowire materials, according to the present invention are another advantageous application. Biomolecules, such as e.g. peptides, proteins, nucleic acids, but more generally essentially any organic and inorganic molecule, such as e.g. polymers or molecules of medical or pharmaceutical interest, can attach to individual nanowires or bundles of nanowires either directly, or via intermediate metal particles, particularly Au (gold) particles. The fact that the M₆C_{y}H_{z} materials may contain for example sulfur means that they have a high affinity to Au surfaces or Au particles via the S—Au bond. The Au particles can then be attached to proteins or other molecules which act as very specific sensors via the lock and key principle (i.e. for example antigen-antibody combinations). FIG. 10 shows a nanowire 60 or a bundle of nanowires 60 comprising on one of the ends of said nanowire 60 or bundle of nanowires 60 an Au particle 62, attached thereon by means of e.g. S—Au bond. Via Au—S—C bridge a first biomolecule 64, for example an antigen is attached, which is essentially present in a non-deformed, naturally occurring configuration. A second biomolecule 66, for example the corresponding antibody, can now interact and attach to said first biomolecule 64. An arrangement of the present invention provides the advantage that in such an arrangement the configuration of the first biomolecule 64 is not or only minimally influenced, so that a recognition process between both biomolecules 64, 66 is not or only minimally altered when compared to the recognition process under physiological conditions and/or in solution. In addition to an attachment of molecules via a S—Au-bond an attachment can also be achieved on basis of various other bonds known to a skilled person.

As outlined above, an array according to the present invention can be used for detecting a binding of a target molecule to said molecule provided on said at least one material or material bundle.

The present invention provides also a method of arranging an array, said method comprising providing at least one material or material bundle, for example at least one nanowire or bundle of nanowires, said material being a material according to the present invention, and arranging said at least one material or material bundle on a substrate or on a template on a substrate. The length axis of said material or material bundle extends essentially non-parallel to the surface of said substrate and/or said template on said substrate. This method comprises also the step of attaching a molecule to the end of said at least one material or material bundle remote from said substrate.

The present application provides also a sensor comprising M₆C_{y}H_{z} material according to the present invention and a method of attaching a molecule, in particular a biomolecule, via a particle, in particular a gold particle, or directly to a material according to the present invention. When used in a sensor, a M₆C_{y}H_{z} material or material bundle, for example a nanowire or bundle of nanowires, according to the present invention can be attached to electrodes, or to a surface or can be in solution.

FIG. 11 shows an array of nanowires or bundles of nanowires 70 having a first molecule 76A attached to one of its ends, while the other end thereof is extending essentially non-parallel, preferably essentially vertically, from a template 72. The templates 72 are arranged in form of an array on a substrate 74. A second molecule 76B can get in contact with said first molecule 76A, and in case both molecules are matching together, they will associate and form a molecular lock- and key-complex 76, in analogy e.g. to an antigen-antibody-complex. The term “molecular lock- and key-complex” as used in the present invention comprises any complex permitting a matching of molecules resulting in the formation of a complex and comprises a matching of molecules to an antigen-antibody-complex, but is not restricted to antigen-antibody-complexes. Exemplarily, FIG. 11 shows an array of six templates having each one nanowire or bundle of nanowire. It should be understood that depending on the specific desired application various other arrangements can be designed, such as e.g. arrays on basis of standard 96 well microtiter plates. Moreover, for example, several nanowires with attached biomolecule can be present on a single template. In addition thereto, also arrays comprising two or more different attached biomolecules 76A can be provided. In particular, in an arrangement according to FIG. 11, M₆C_{y}H_{z} material incorporating sulfur attached to patterned or unpatterned Au metal surfaces or objects made of Au can be used. The S atoms in the structure facilitate attachment of other objects to Au, as shown in the example in FIG. 11.

Moreover, a material according to the present invention which can be conducting, superconducting or semiconducting can be connected to and/or integrated in electric circuitry and can provide miniaturized circuitry.

For example, M₆C_{y}H_{z} material or bundles of said material, for example nanowires or bundles of nanowires, can be attached to a single contact or lead or to multiple contacts or other devices by means of electrophoresis or dielectrophoresis. Electrophoresis and dielectrophoresis can be performed according to methods of the state of the art and are described for example in “Dielectrophoresis” by H. Pohl (Cambridge, 1978) or “Electromechanics of Particles” T. B. Jones (Cambridge, 1995)

FIG. 12 shows a 4-terminal device in which a Mo₆S_{y}I_{z} nanowire or bundle of nanowires is deposited on the contacts by dielectrophoresis, whereby a bundle of Mo₆S_{4.5}I_{4.5} suspended in isopropanol has been positioned across the electrodes by means an alternating electric field made to contact from an external circuit. M₆C_{y}H_{z} materials can also be used for the construction of devices using DC electrophoresis which is used in order to self-assemble nanowires on tips, as parts of sensors or other devices, or for single-tip or multi-tip field-emission devices.

The following examples illustrate the invention without limiting it thereto.

### EXAMPLE 1

### Synthesis

The synthesis is performed in a sealed and evacuated quartz ampoule having diameter of 19 mm and a length of 140 mm, containing platelets of Mo sheet metal (Aldrich, molybdenum foil 0.1 mm thick, 99.9+%), S (Aldrich, sulfur powder, 99.98%) and I₂ (Aldrich, 99.999+%) in the amounts 6:4:6 (Mo: 0.8925 g, S: 0.1988 g, I₂: 1.1805 g). The ampoule is placed in a single-zone furnace (LINDBERG STF 55346C) and heated from room temperature to a temperature of 1070° C. at a rate 8 K per hour. This temperature is kept stable for 72 hours. The ampoule is then cooled at 1.5 K per minute. The resulting material contains a large amount of material in the form of furry-like material (FIG. 2), which upon closer examination contains ropes of material with stoichiometry given by Mo₆S₃I₆.

Composition

The composition, as determined by EA (elemental analysis) is given as Mo₆S₃I₆.

found, %: Mo 40.4; S 6.4; I 153.1. (measurement tolerance±0.2-0.3%) calculated for Mo₆S₃I₆, %: Mo 40.2; S 6.7; I 153.1.

The chemical composition corresponds to the molar ratio Mo:S:I=2:1:2.

Structure

The structure of the material as grown is essentially crystalline in the usual sense. X-ray data shown rather broad peaks with no narrow well-defined sharp crystal peaks.

### EXAMPLE 2

### Synthesis

The synthesis is performed in sealed and evacuated quartz ampoule (diameter 19 mm, length 140 mm), containing platelets of Mo sheet metal (Aldrich, molybdenum foil 0.1 mm thick, 99.9+%), S (Aldrich, sulfur powder, 99.98%) and I₂ (Aldrich, 99.999+%) in the amounts 6:4:4 (Mo: 0.8981 g, S: 0.2000 g, I₂: 0.7919 g). The ampoule is placed in a single-zone furnace (LINDBERG STF 55346C) and heated from room temperature to a temperature of 1150° C. at a rate 8 K per hour. This temperature is kept stable for 72 hours. The ampoule is then cooled at 1.5 K per minute. The resulting material contains a large amount of material in the form of furry-like material (FIG. 2), which upon closer examination contains ropes of material with stoichiometry given by Mo₆S_{4.5}I_{4.5}.

Composition

The composition, as determined EA (elemental analysis) is given as Mo₆S_{4.5}I_{4.5}.

| | |
|---|---|
| found %: | Mo 43.5; S 11.2; I 45.3 (measure |
| | tolerance ±0.3%) |
| calculated for Mo₆S_{4.5}I_{4.5}, %: | Mo 44.6; S 11.2; I 44.2. |

The chemical composition corresponds to the molar ratio Mo:S:I = 1.3:1:1.

Structure

The structure of the material as grown is not crystalline in the usual sense, particularly along the direction of the wires, because of the very weak forces in-between the wires lead to bending and twisting of individual molecular strands within a bundle. X-ray data shown rather broad peaks with no narrow well-defined sharp crystal peaks, particularly in the direction along the wires.

The microscopic structure cannot be described in terms of rolled-up sheets of layered dichalcogenide material, and cannot be described to be fullerene-like in structure, composed of M₆CₓH_{y} units repeated lengthwise to form a polymer. These in turn forms bundles comprising of many individual polymer strands, without covalent bonds between individual polymer strands.

The morphology of the material is in the form of needles or ropes or wires, composed of small-diameter columnar structures.

The material can be dispersed in a variety of solvents, such as isopropanol, methanol, water etc., using an ultrasonic bath, to various degrees, where the mean diameter of the nanowires thus obtained depends on the dilution and on the extent of sonification. Thinner diameters are obtained with more dilute solutions, and monodisperse dispersions of nanowires with mean diameter less than 4 nm can be obtained using this method with appropriate dilutions.

The materials are grown at temperatures above 1000° C. Their stoichiometry is variable, and different compounds exist, which have different values y and z.

1. A material of the general formula M₆C_{y}H_{z}, wherein M designates a transition metal, C designates a chalcogen, H designates a halogen, and wherein y and z may be of from 0 to 10 such that 8.2<y+z<10, wherein the material is in the form of nanowires, nano-ropes, nanorods, whiskers or needles.

2. The material according to claim 1, wherein M is a transition metal selected from the group consisting of Mo, W, V, Ti, Ta, Nb, Zn, Hf, Re and Ru.

3. The material according to claim 1, wherein M represents a mixture of two or more transition metals.

4. The material according to claim 1, wherein C=S, Se, Te.

5. The material according to claim 1, wherein C represents a mixture of two or more chalcogens.

6. The material according to claim 1, wherein the halogen H=I, Br, Cl or F.

7. The material according to claim 1, wherein H represents a mixture of two or more halogens.

8. The material according to claim 1, wherein 0<y<10, 0<z<10 and 8.2≦y+z<10.

9. The material according to claim 1, wherein H has a property of being replaced by an ion elected from the group consisting of elements in the groups III-VIII.

10. The material according to claim 1, additionally containing intercalated or interstitial ions, atoms or molecules, selected from the group consisting of alkali metals, alkaline-earth metals, transition metals, elements belonging to groups III-VIII and any organic donors or acceptors.

11. The material according to claim 1, wherein the material has a substantially circular cross-section.

12. The material according to claim 1, wherein the material is superconducting.

13. The material according to claim 1, wherein the material is metallic or semiconducting.

14. A method for the production of a material according to claim 1, the method comprising (i) mixing individual constituent elements, (ii) heating the individual constituent elements in a sealed container under reduced pressure, and (iii) heating the individual constituent elements above a temperature of 1000° C. or more for a duration of time.

15. The method according to claim 11, wherein the at least some of the constituent elements are replaced by one or more replacing elements or compounds.

16. A method comprising incorporating a material according to claim 1 in electronic, chemical, optical or mechanical applications.

17. The method according to claim 16, wherein the application is a catalyst in dry form or in suspension or as a catalytic component.

18. The method according to claim 16, wherein said method is selected from the group consisting of incorporating in a field-emission device, in a superconducting application, in a proximity-coupled network, in a quantum interference network, in devices incorporating said material in 2-, 3-, 4- or multi-terminal configuration, and a use for enhancing electrical, optical, magnetic, mechanical and tribological properties of polymers and glasses by incorporating said material in said polymers and glasses.

19. The method according to claim 16, said material having a property of a lubricating agent.

20. A method of varying a material characteristics of a material according to claim 1, said method comprising:
selecting composition parameters y and z, and/or
incorporating dopants or substituents in said material.

21. An electric device comprising:
at least one material or a material bundle comprising said at least one material arranged on a substrate, said at least one material being a material according to claim 1; and
at least one contact arranged on said substrate and passing over said at least one material or the material bundle, said at least one contact being connected with or connectable to a circuitry of the device.

22. The device of claim 21, wherein said device is adapted to detect physical or chemical influences acting on said at least one material or the material bundle and/or said at least one contact.

23. The device of claim 22, said device being adapted to detect physical or chemical influences selected from the group consisting of influences due to molecules attaching to and/or coming into contact with said at least one material or material bundle or said contact(s), light of different wavelengths, and mechanical influences.

24. A method of arranging a material according to claim 1 in a electric device, said method comprising:
arranging at least the material or a material bundle comprising said material on a substrate;
providing said material or the material bundle with one or more contacts, at least one of said one or more contacts being in connection with or connectable to a circuitry of said electric device.

25. An array comprising:
at least one material or a material bundle comprising said at least one material, said at least one material being a material according to claim 1, said at least one material or the material bundle being provided on a substrate, the length axis of said at least one material or the material bundle extending essentially non-parallel to said substrate, and
said at least one material or the material bundle being provided with a molecule on an end distant from said substrate.

26. The array of claim 25, wherein said at least one material or the material bundle is attached to said substrate or attached to a template arranged on said substrate.

27. The array of claim 25, wherein said molecule is attached via a particle, preferably via a gold particle, to said at least one material or the material bundle.

28. A method comprising incorporating an array according to claim 25 in a device for detecting binding of a molecule to said molecule provided on said at least one material or the material bundle.

29. A method of arranging an array, said method comprising
providing at least one material or a material bundle comprising said at least one material, said material being a material according to claim 1,
arranging said at least one material or the material bundle on a substrate or on a template on a substrate, the length axis of said material or the material bundle extending essentially non-parallel to the surface of said substrate and/or said template on said substrate, and attaching a molecule to an end of said at least one material or the material bundle remote from said substrate.

30. A method comprising incorporating a material according to claim 1 in a device for electric applications, said material being connected to or integrated in an electric circuitry.

31. A material according to claim 1, said material being a nanowire, nano-rope, nanorod, whisker or needle having a molecule on one end thereof.

32. The material according to claim 31, said material being a sensor.

33. A composition comprising a material according to claim 1 and one or more materials selected from the group consisting of a superconducting compound, a lubricating compound, oil, polymer, glass, and a gaseous compound.

34. The material of claim 1, wherein M is molybdenum.

35. The material of claim 1, wherein the material is obtainable by a process comprising mixing constituent elements in a desired mass ratio, placing the constituent elements in a container, evacuating the container and heating the constituent elements to a temperature above 1000° C. for a predetermined length of time.

36. The method of claim 15, wherein the one or more replacing elements or compounds comprises MoS₂.
